(19) United States
(12) Patent Application Publication
(10) Pub. No.: US 2007/0171383 A1
(43) Pub. Date: Jul. 26, 2007

(54) Portable battlewall display stand

(75) Inventor: Dimitrios Deves, Toney, AL (US)

Correspondence Address: BROWN INTERNATIONAL CORPORATION, 2103-A WEST FERRY WAY, HUNTSVILLE, AL, 35801, US

(73) Assignees: BROWN INTERNATIONAL CORPORATION; Mr. DIMITRIOS DEVES, TONEY, AL (US)

(21) Appl. No.: 11/583,310

(22) Filed: Oct. 19, 2006

Related U.S. Application Data
(60) Provisional application No. 60/761,299, filed on Jan. 23, 2006.

(51) Int. Cl. G03B 21/14

(52) U.S. Cl. 353/79

(57) ABSTRACT

The Portable Battlewall Display Stand provides a flexible, reliable, safe and rapid method for the mounting of flat panel displays and short focal length projectors in a single or dual mode. It offers the capability of coupling the stands, for flat panel display/projector media multi-use. Its tubular frame provides telescopic expansion, rigidity and light weight features, without sacrificing safety and reliability, by use of positive mechanical fastening hardware. It can be readily disassembled for transport and storage, presenting small volume for storage.

This application is a continuance of U.S.60/761299.

### CROSS-REFERENCE TO RELATED APPLICATIONS

Not Applicable

### STATEMENT REGARDING FEDERALLY SPONSERED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Portable Battlewall Display Stand was designed to replace existing tactical display systems which are too large, cumbersome, difficult to erect, heavy, and costly. The idea was to design a portable stand that is stable, light weight, easy to erect and tear down, occupies a small footprint, supports newer short focal length projectors, and could be transported in a small package while providing the features and functions of larger display systems. The environment in which these stands are used is in a tent, or on a stage that requires the stand to have additional rigidity to support various projection screens, projectors, or flat panel displays. The design allows for a combination of projector/flat panel display in a multi-combination mode for enhanced viewing experience.

### BRIEF SUMMARY OF THE INVENTION

The Portable Battlewall Display Stand provides a mobile, expandable, rigid and multi-configuration solution, for the accommodation and support of projector media and flat panel displays, in stand alone mode or in multi mode configuration. Its design utilizes the advantages of a short focal length projector, providing full adjustment capabilities and an alternative mount position. It supports a dimensional variety of flat panel displays, providing the necessary viewing angle adjustments and multi mode mount capabilities. The adjustable leveling feet insure the level position of the stand in rough terrain and its telescopically adjustable height insures ceiling comparability with field apparatus, such as tents, thus allowing the use of the stand in a field environment. It minimizes the set-up and tear-down time by offering a telescopic method to erect the structure, secured by mechanical fasteners which pronounce tool-less operation, performed by a single operator. The same method allows the disassembly and storage of the structure within a volume of 9 cubic feet, weighting approx. 60 lbs. Coupling of multiple stands, occupied by the selected media, provides an infinite viewing area, in a multi-media spectrum, composed of projector and flat panel displays. The stand offers a variety of accessories designed to aid the accommodation of electronic video-audio components and their cabling media, utilizing a number of secure shelves and a cable organized kit.

### BRIEF DESCRIPTION OF THE SEVERAL VIEWS OF THE DRAWING

FIG. 1 is an exploded view of the tubular base configuration composed of the Base Weldments and the telescopic attachments of the Extended Base and the Internal Posts.

FIG. 2 is the Main Vertical Supports with their featured tabs for the mounting of a flat panel display mounting kit.

FIG. 3 is the Main Horizontal Support featuring the welded receivers for the Upper Extension Bar and the Cantilever Projector Mount.

FIG. 4 is an exploded view of the assembly of the projector mounting apparatus, composed of the Projector Stabilizer Bar, Cross Carriage, Cantilever Projector Mount, Projector Carriage Sleeve, Ram System, Projector Mount Base Plate, and three positive mechanical fasteners (hand knobs).

FIG. 5 is the Upper Extension Bar, featuring the mounting kit location holes.

FIG. 6 is the stand assembly, including the Base Weldment, the Main Vertical Supports, the projector mounting apparatus, the Main Horizontal Support and the Upper Extension Bar, secured by positive mechanical fasteners (hand knobs).

FIG. 7 is an exploded view of the stand assembly (without the projector apparatus attachment and the Upper Extension Bar) in flat panel display configuration mode, including the mounting kit and the flat panel media.

FIG. 8 is an exploded view that illustrates the stand assembly (without the Upper Extension Bar), in projector mode configuration including the projector mounting apparatus, the projector screen and the projector media.

FIG. 9 is an exploded view of the stand assembly in a combination mode, featuring the projector mount apparatus, projector media, projector screen, flat panel display mounting kit and the flat panel display.

FIG. 10 is an exploded view that illustrates the stand assembly (without the projector mounting apparatus), in a dual flat panel display mode, using the flat panel display mounting kits and the flat panel display.

FIG. 11 is two stand assemblies coupled by a single Upper Extension Bar, to produce a multi-combination mode, composed of two projector mounting apparatus, two projector screens, two projector medias, a flat panel display mounting kit and a flat panel display.

FIG. 12 is two stand assemblies coupled by a single Upper Extension Bar, to produce a multi-combination mode, composed of three flat panel display mounting kits and three flat panel display medias.

FIG. 13 is the stand assembly (without the Upper Extension Bar), featuring an inverted Cantilever Projector Mount, a projector screen and a projector media.

FIG. 14 is the stand assembly featuring attached accessories such as shelves, shelf mounting rails and wire management kit.

### DETAILED DESCRIPTION OF THE INVENTION

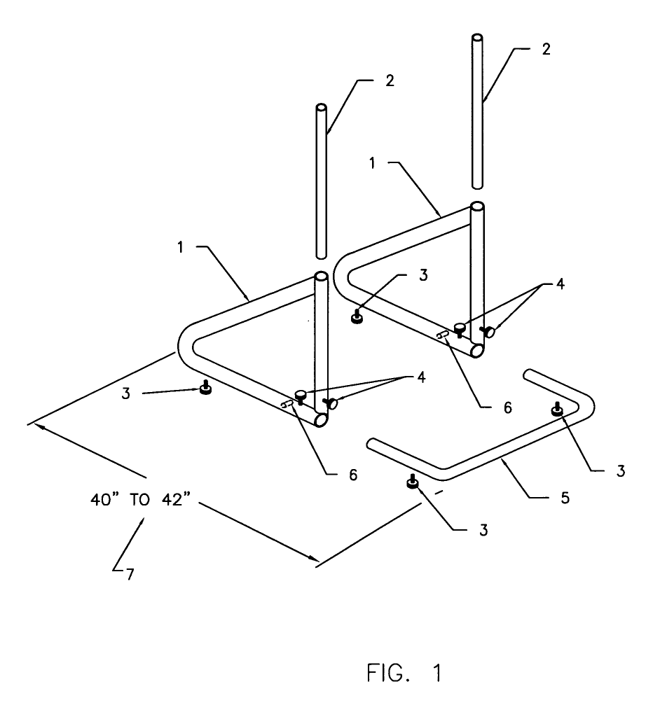

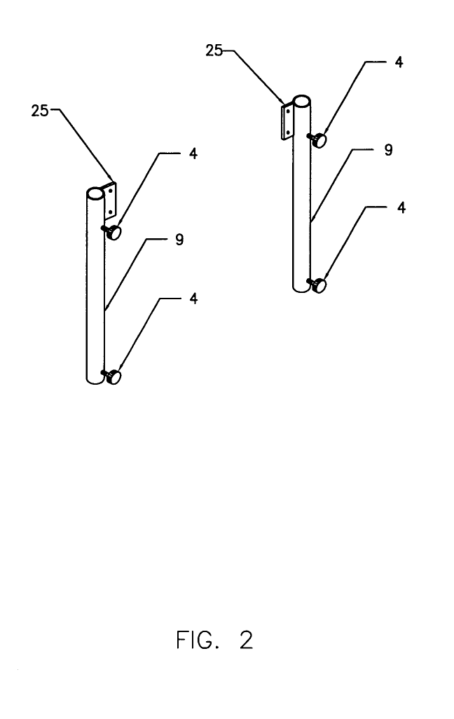

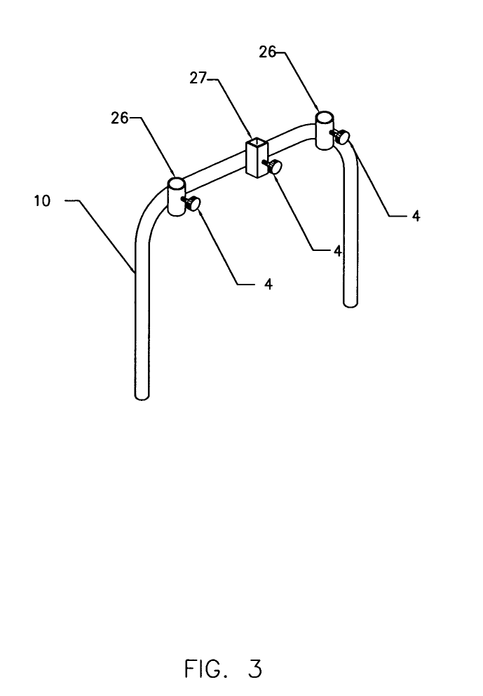

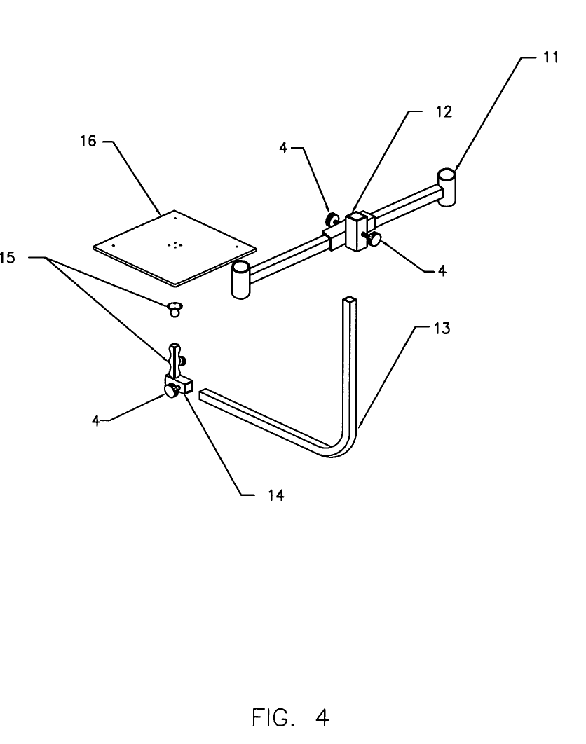

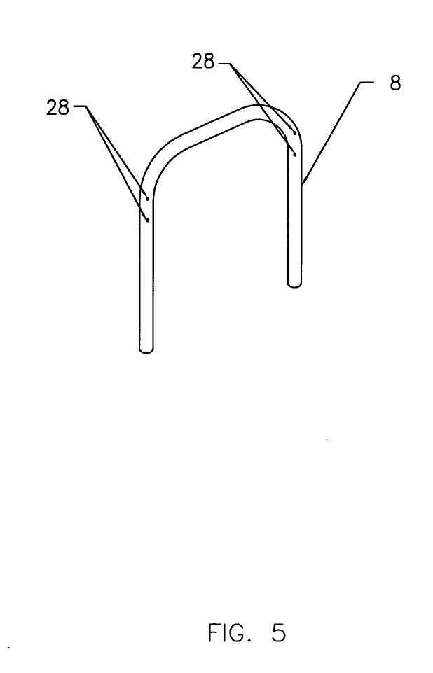

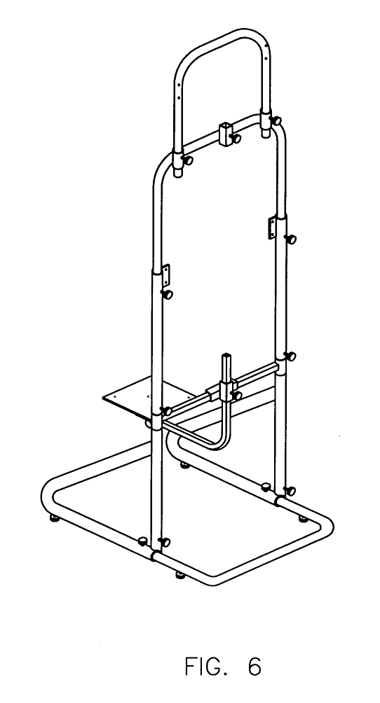

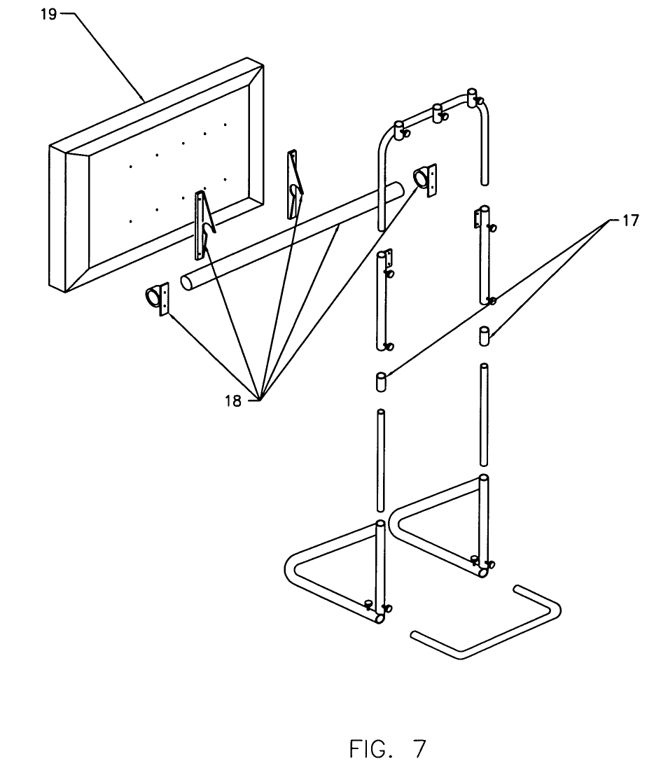

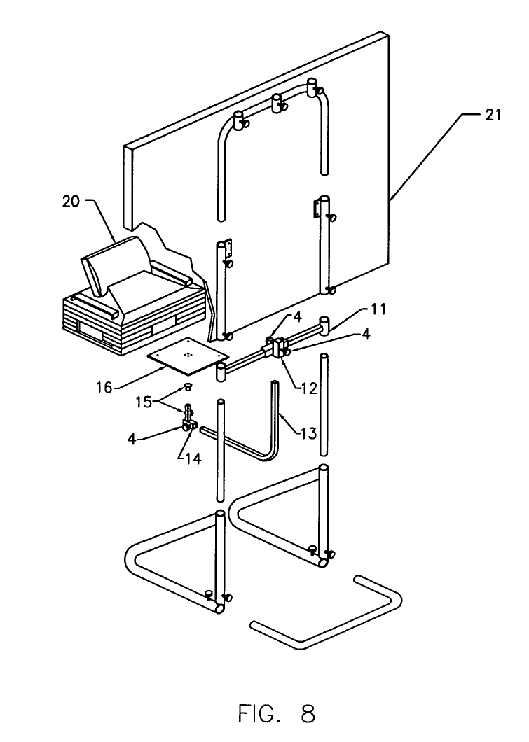

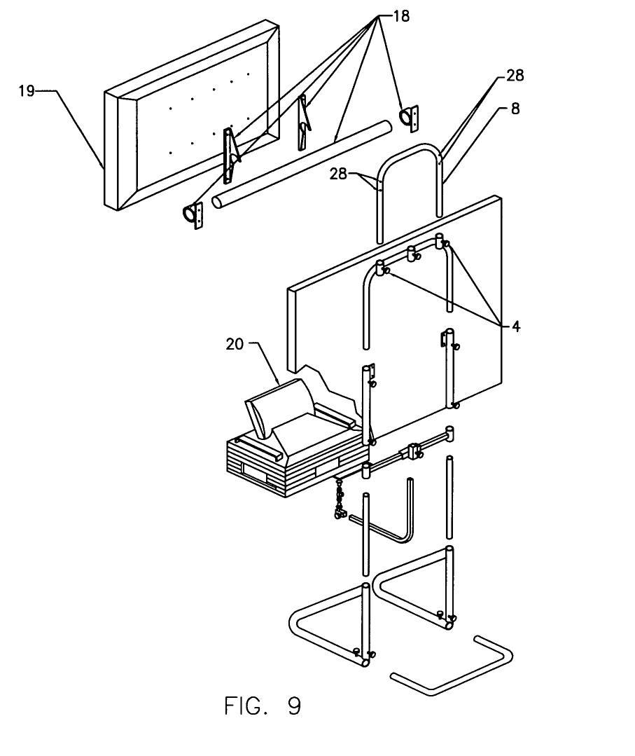

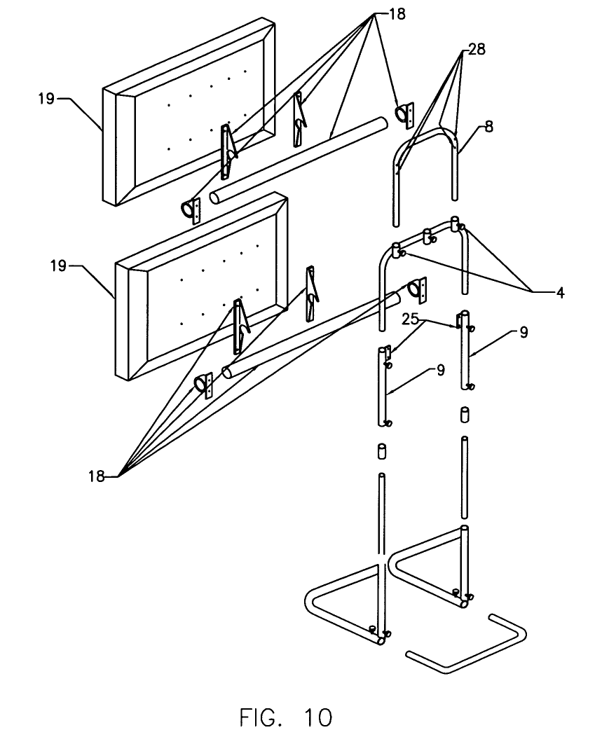

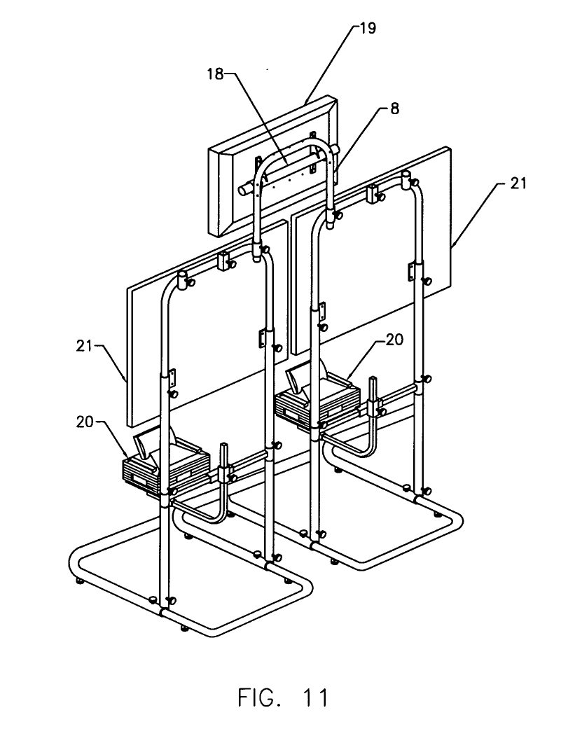

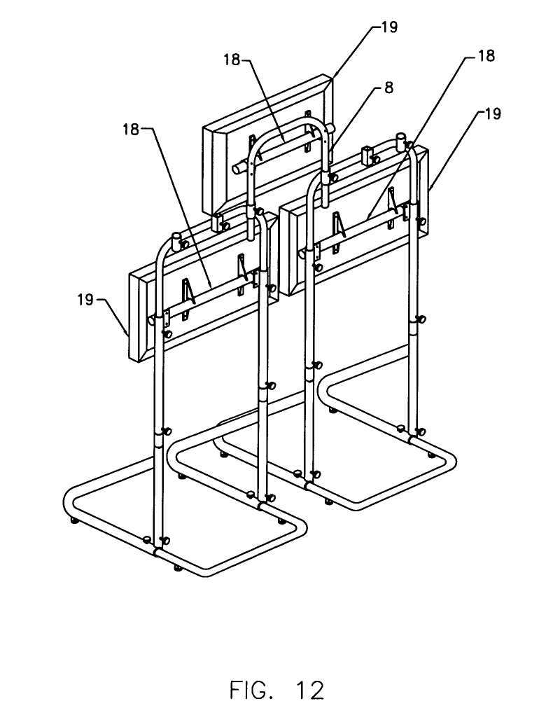

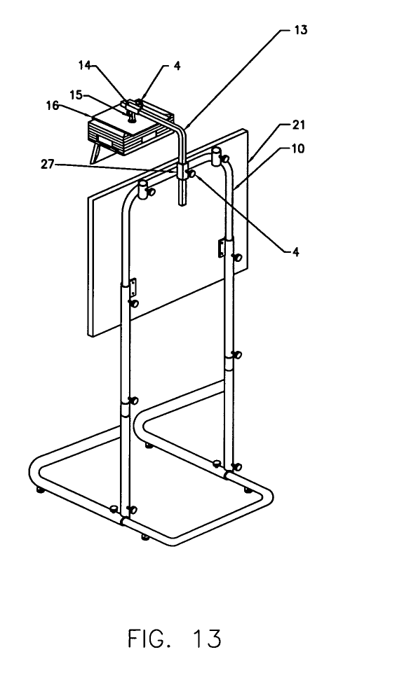

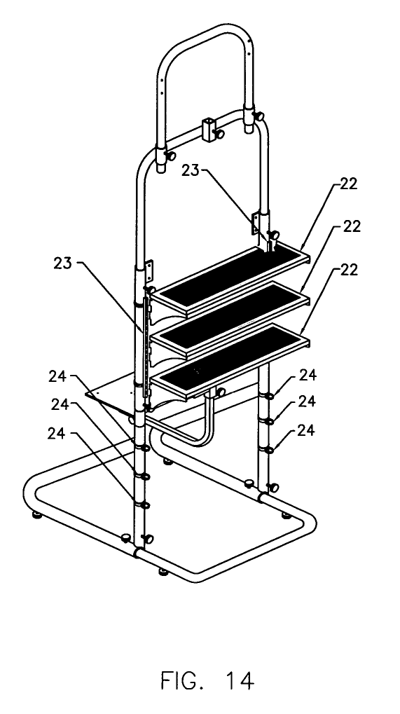

FIGS. 1-14 are as follows:
FIG. 1—The Base.
FIG. 2—The Main Vertical Supports.
FIG. 3—The Main Horizontal Support.
FIG. 4—The Projector Carriage Assembly.
FIG. 5—The Upper Extension Bar.
FIG. 6—Stand Assembly for inclusion on the front page of the patent application publication and patent.
FIG. 7—The stand without projector media.
FIG. 8—Exploded view for projector media configuration.
FIG. 9—Exploded view for the projector media/flat panel display configuration.
FIG. 10—Exploded view for two flat panel displays configuration.
FIG. 11—Coupling stand together using the upper extension bar combining projector media and flat panel display configuration.
FIG. 12—Coupling stands together using the Upper Extension Bar for flat panel displays configuration only.
FIG. 13—Alternative position of the projector assembly.
FIG. 14—Additional accessories added to stand.

FIG. 1 is referred to as the Base of the stand. The Base FIG. 1 consists of a pair of tubular vertical triangles known as the Base Weldments 1, with a pair of Internal Posts 2 and an Extended Base 5. FIG. 1 also shows four Leveling Mounts 3 and four positive mechanical fasteners (hand knobs) 4. The extended Base 5 allows the expansion of the footprint 7 from 40 inches minimum to 42 inches maximum. Each Base Weldment 1 has an Internal Stopper 6 pre-inserted to control the maximum allowable insertion for the safety and stability of the structure. The secured fastening of the extended Base 5 is obtained by two positive mechanical fasteners (hand knobs) 4. The pair of Internal Posts 2 is for attachment of the Projector Carriage Assembly FIG. 4 and the two Main Vertical Supports FIG. 2. The method of secured fastening of the two Internal Posts 2 is also obtained by two positive mechanical fasteners (hand knobs) 4. Leveling of the Base FIG. 1 is obtained by four threaded Leveling Mounts 3, within ten degrees of horizontal tilt.

FIG. 2 shows the two Main Vertical Supports 9. They are two tubular members, which further allow the erection of the stand. Their primary goal is to provide tabs 25 to mount a flat panel mounting kit 18, which in turn provides mounting for a flat panel display 19 (as shown in FIG. 7). In addition, the two Main Vertical Supports 9 secure the Main Horizontal Support 10 (FIG. 3). The secured fastening to the two Internal Posts 2 (FIG. 1), is obtained by two positive mechanical fasteners (hand knobs) 4 located on the lower ends of each of the Main Vertical Supports 9. The secured fastening of the Main Horizontal Support 10 (FIG. 3) to the two Main Vertical Supports 9 is obtained by two positive mechanical fasteners (hand knobs) 4 located at the upper end of each of the two Main Vertical Supports 9.

FIG. 3 shows the Main Horizontal Support 10. It consists of a tubular member who telescopically controls the height of the media apparatus such as a projector screen 21 (FIG. 8) and through the use of the welded Upper Extension Bar Receiver 26, supports the Upper Extension Bar 8 (FIG. 5) for multiple coupling stand configurations FIGS. 11 & 12 and additional media or accessory mounting. The fastening of the Main Horizontal Support 10 to the Main Vertical Support 9 is secured by two positive mechanical fasteners (hand knobs) 4. Said support 10 also allows the repositioning of the Projector Carriage Assembly 13, Projector Carriage Sleeve 14, Ram System 15, and a Projector Mount Base Plate 16 in FIG. 4, into an alternative configuration FIG. 13 through the use of the welded Cantilever Projector Mount Receiver 27 and securing with one positive mechanical fastener (hand knob) 4.

FIG. 4 Illustrates the Projector Carriage Assembly comprised of two sub-assemblies. The Projector Stabilizer Bar 11, with a Cross Carriage 12, and a Cantilever Projector Mount assembly composed of a Cantilever Projector Mount 13, Projector Carriage Sleeve 14, Ram System 15, and a Projector Mount Base Plate 16. The Projector Stabilizer Bar 11 consists of a square bar occupied by a Cross Carriage 12 for allowing the horizontal and vertical traveling of the Cantilever Projector Mount Assembly comprised of the Cantilever Projector Mount 13, Projector Carriage Sleeve 14, Ram System 15, and Projector Mount Base Plate 16. The desired distance is obtained by two positive mechanical fasteners (hand knobs) 4. The Cantilever Projector Mount Assembly is composed of the Cantilever Projector Mount 13 a square tube which is occupied by the Projector Carriage Sleeve 14 and Projector Mount Base Plate 16, and a Ram System 15 in conjunction with a Projector Mount Base Plate 16 that allows the fastening of the projector 20 (FIG. 8) providing full pitch, yaw and roll capabilities. The Projector Carriage Sleeve 14 adjusts for the required distance for best performance. All the control and fastening of the Cantilever Projector Mount Assembly is obtained by the use of one positive mechanical fastener (hand knob) 4 for securing the Projector Carriage Sleeve 14 and the Ram System 15. The configuration of the above sub-assemblies is illustrated in FIG. 8.

FIG. 5 The Upper Extension Bar 8 is a tubular device that allows the installation of additional overhead media of the existing projector screen or flat panel display through the use of a flat panel mounting kit 18 utilizing the mounting kit location holes 28 (FIGS. 9 & 10). It provides an adjustable height control, through the telescopic insertion into the Main Horizontal Support 10 and fastens securely by the use of two positive mechanical fasteners (hand knobs) 4. The Upper Extension Bar 8 may be positioned in a way to couple multiple assemblies FIG. 11 & FIG. 12, thus providing an infinite number of viewed displays in a theater mode. The Upper Extension Bar 8 may be interchangeable to accommodate larger than 48″ LCD screens, without sacrificing stability or functionality.

FIG. 6 Stand Assembly for inclusion on the front page of the patent application publication and patent.

FIG. 7 Demonstrates the absence of the projector media by deleting the Projector Stabilizer Bar Assembly 11 & 12 (FIG. 4) and substituting two Tubular Spacers 17 to allow the mounting of the flat panel display only.

FIG. 8 Demonstrates the exploded view of the configuration needed for the projector media. The Projector Stabilizer Bar Assembly 11 & 12, with two positive mechanical fasteners (hand knobs) 4, the Cantilever Projector Mount Assembly 13, 14, 15 & 16 with one positive mechanical fastener (hand knob) 4 with the projector 20 and projector screen 21.

FIG. 9 Demonstrates the exploded view of the configuration for the projector media/flat panel display 19 using the Upper Extension Bar 8, two positive mechanical fasteners (hand knobs) 4, and mounting kit 18 needed to support the flat panel display 19.

FIG. 10 Demonstrates the exploded view of the stand configuration for two flat panel displays 19, by mounting one flat panel display 19 to the Upper Extension Bar 8 using the mounting kit location holes 28 and a mounting kit 18. Two positive mechanical fasteners (hand knobs) 4 are used to secure said Upper Extension Bar 8. The second flat panel display is secured onto the Tabs 25 located on the Main Vertical Supports 9 by using a second mounting kit 18.

FIG. 11 Demonstrates the use of the Upper Extension Bar 8 to couple two stands together for double projectors 20, double projector screens 21, and a flat panel display 19 using one mounting kit 18.

FIG. 12 Demonstrates the use of the Upper Extension Bar 8 to couple two stands together to support three flat panel displays 19 using three mounting kits 18.

FIG. 13 Demonstrates the use of the Cantilever Projector Mount Receiver 27 located on the Main Horizontal Support 10 that allows invertion of the Projector Carriage Assembly 13, 14, 15, and 16. One positive mechanical fastener (hand knob) 4 is used to secure said assembly over head of the projector screen 21.

FIG. 14 Demonstrates the use of shelving accessories 22 supported by shelving Weldments 23. Also demonstrates the use of a wire management kit 24.

I claim:

1. The portable stand is a lightweight tubular frame which is composed of weldments and bent tubular members secured by positive mechanical fasteners (hand knobs), thus providing expandable structure capabilities that supports flat panel displays, projector's screen and projector, and supporting accessories i.e.; equipment shelves and wire routing clamps.

2. The portable stand in claim 1 has Four Leveling Mounts attached to the Base eliminates instability caused by terrain variations.

3. The portable stand in claim 1 has two Internal Posts that provide structural integrity from the base to the main vertical supports of the stand.

4. The portable stand in claim 1 has a Cantilever Projector Mount Assembly that provides for individual in and out, left and right, up and down coarse projector adjustment.

5. The Cantilever Projector Mount in claim 4 has a Ram System attached to the Cantilever Projector Mount that allows for fine adjustment of the projector mounting plate pitch, yaw and roll.

6. Each main vertical support of the portable stand in claim 1 provides a tab which acts as a hard point for the mounting of a flat panel display

7. The Main Horizontal Support Bar of the portable stand in claim 1 provides the mounting for a projector screen, coupling of stands, supports the Upper Extension Bar and provides the alternative position for the cantilever mount assembly.

8. The Upper Extension Bar provides an alternative mounting location for a flat panel display or a projector screen while providing an optional physical interconnect between stands.
